(19) United States
(12) Patent Application Publication
(10) Pub. No.: US 2023/0337631 A1
(43) Pub. Date: Oct. 26, 2023

(54) INFORMATION PROCESSING DEVICE AND INFORMATION PROCESSING METHOD

(71) Applicant: SONY GROUP CORPORATION, TOKYO (JP)

(72) Inventors: YUJI KAWAMURA, TOKYO (JP); MASATOSHI FUNABASHI, TOKYO (JP)

(21) Appl. No.: 17/796,447

(22) PCT Filed: Jan. 22, 2021
(86) PCT No.: PCT/JP2021/002176

§ 371 Date: Jul. 29, 2022

(30) Foreign Application Priority Data
Feb. 7, 2020 (JP) 2020-019874

(51) Int. Cl. A01K 29/00; A01K 15/02

(52) U.S. Cl. CPC A01K 15/021; A01K 29/005

(57) ABSTRACT

The present technology relates to an information processing device and an information processing method that enable effective the desert greening and ecosystem regeneration using livestock.

The information processing device includes an evaluation unit that evaluates a degree of contribution of a herd of grazing livestock to desert greening or ecosystem regeneration based on at least one of a behavior content of the herd and a state of a passing area which is an area through which the herd has passed. The present technology can be applied to, for example, a system for performing desert greening and ecosystem regeneration using livestock.

### TECHNICAL FIELD

The present technology relates to an information processing device and an information processing method, and more particularly to an information processing device and an information processing method suitable for use in the case of performing the desert greening and ecosystem regeneration using livestock.

### BACKGROUND ART

Conventionally, a method of performing the desert greening and ecosystem regeneration by systematically moving a herd of livestock has been known (see, for example, NPL 1).

### CITATION LIST

### Non Patent Literature

[NPL 1] Allan Savory, The Grazing Revolution: A Radical Plan to Save the Earth (TED Books Book 39)

### SUMMARY

### Technical Problem

On the other hand, it is desired to more effectively perform the desert greening and ecosystem regeneration using the method described in NPL 1.

The present technology was made in view of such a situation, and enables effective the desert greening and ecosystem regeneration using livestock.

### Solution to Problem

An information processing device according to one aspect of the present technology includes an evaluation unit that evaluates a degree of contribution of a herd of grazing livestock to desert greening or ecosystem regeneration based on at least one of a behavior content of the herd and a state of a passing area which is an area through which the herd has passed.

An information processing method according to one aspect of the present technology causes an information processing device to evaluate a degree of contribution of a herd of grazing livestock to desert greening or ecosystem regeneration based on at least one of a behavior content of the herd and a state of a passing area which is an area through which the herd has passed.

In one aspect of the present technology, the degree of contribution of the herd to the desert greening or ecosystem regeneration is evaluated based on at least one of a behavior content of the herd and a state of a passing area which is an area through which the herd has passed.

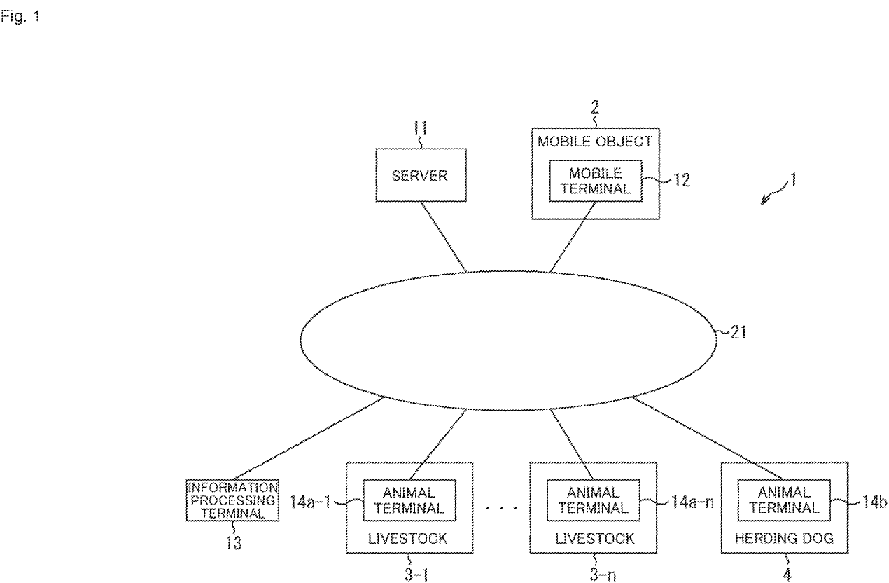

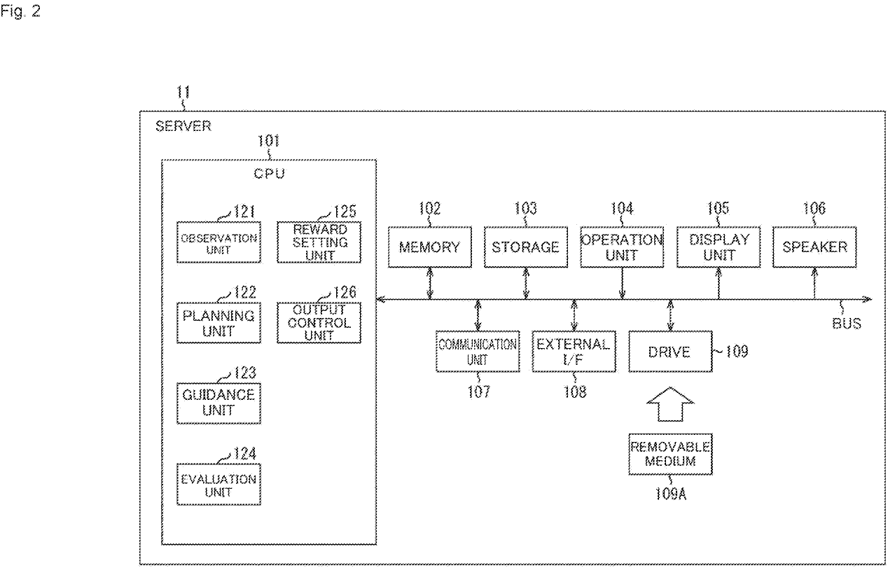

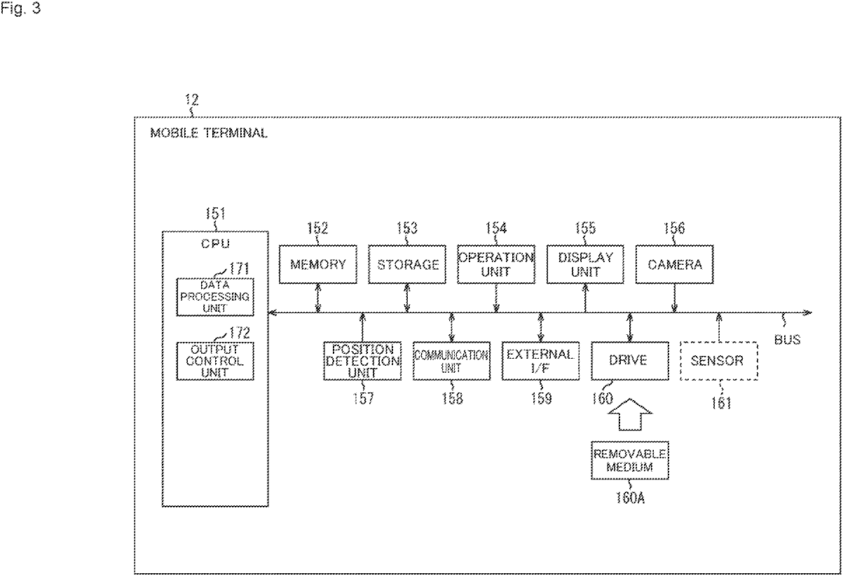

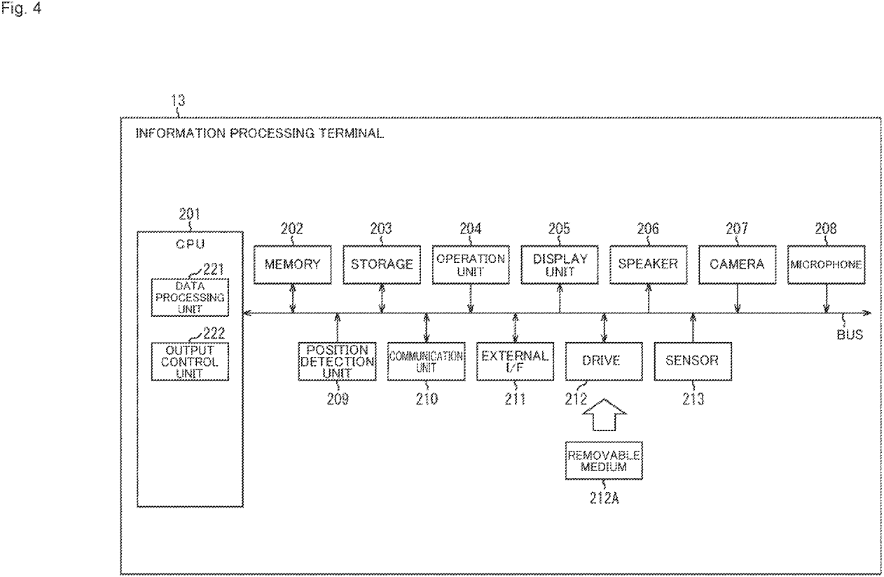

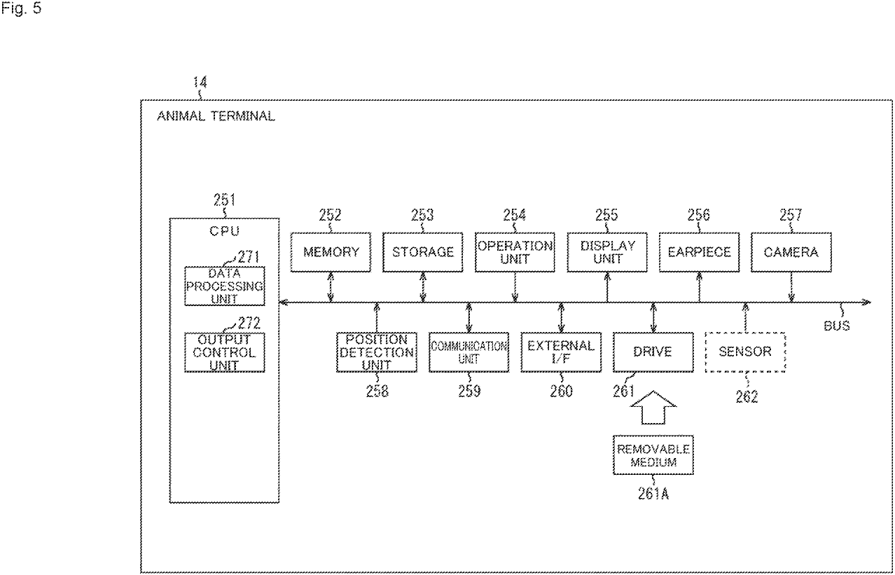

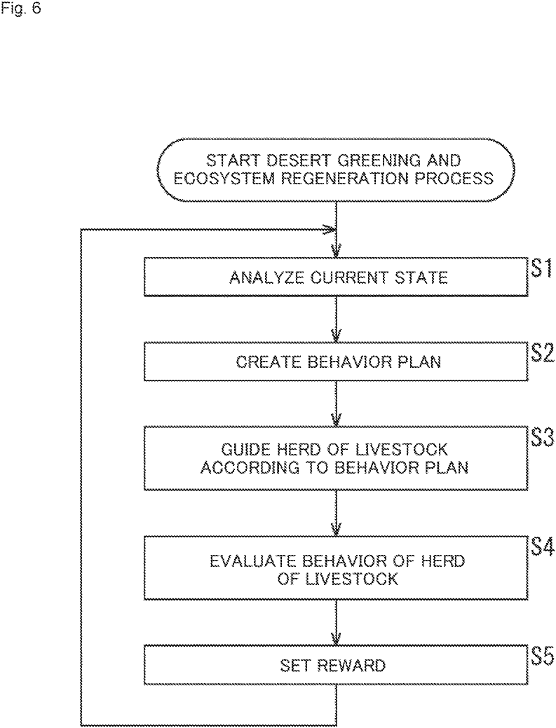

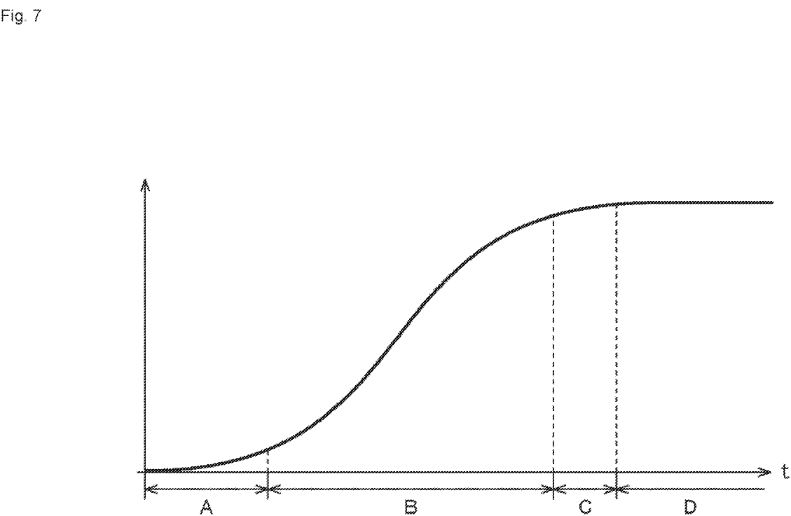

### BRIEF DESCRIPTION OF DRAWINGS

[FIG. 1] FIG. 1 is a block diagram illustrating an exemplary configuration of an information processing system to which the present technology is applied.

[FIG. 2] FIG. 2 is a block diagram illustrating an exemplary configuration of a server.

[FIG. 3] FIG. 3 is a block diagram illustrating an exemplary configuration of a mobile terminal.

[FIG. 4] FIG. 4 is a block diagram illustrating an exemplary configuration of an information processing terminal.

[FIG. 5] FIG. 5 is a block diagram illustrating an exemplary configuration of an animal terminal.

[FIG. 6] FIG. 6 is a flowchart for explaining the desert greening and ecosystem regeneration processing.

[FIG. 7] FIG. 7 is a graph illustrating an example of a grass growth curve.

### DESCRIPTION OF EMBODIMENTS

An embodiment of the present technique will be described below. The description will be made in the following order.
1. Background of present technology
2. Embodiment
3. Modified example
4. Others

### 1. Background of Present Technology

Conventionally, it has been thought that desertification progresses when herbivores such as livestock eat up the grass. However, in practice, as described in NPL 1, it is known that herbivores walks while eating grass and promote plant growth to produce soil organic matter.

Specifically, in grasslands such as savanna where the dry season and the rainy season are separated, plants such as grass grow during the rainy season, and the grass and the like die wither in the dry season. If the withered grass in the over-resting state is left as it is, it becomes difficult for sunlight to reach the surface, so that it becomes difficult for sprouts to sprout even in the rainy season, and the growth of new plants is hindered. As a result, soil capping occurs in which the surface is hardened by microorganisms and the like, and a vicious cycle occurs in which the growth of new plants becomes more difficult. In addition, the capped soil makes it difficult for rain to penetrate into the ground, and soil erosion is likely to occur. In this way, desertification progresses.

On the other hand, when animals such as livestock move to the land where grass and the like have withered (hereinafter referred to as withered area), and the withered grass is knocked down or eaten, the withered grass in the over-resting state is reduced. Thus, sunlight easily reaches the surface. In addition, the capped soil is cracked by animal hoofs and the like, and the soil is fertilized by animal manure. Thus, water and organic matter are supplied to the capped soil and the soil that promotes plant growth spreads. In this way, desertification is prevented and ecosystems are regenerated.

NPL 1 shows that the desert greening and ecosystem regeneration are realized by systematically moving a herd of livestock. That is, NPL 1 shows that a cycle in which desertification is stopped by effectively moving a herd of livestock and capped (desertified) soil is regenerated (fertilized), and the ecosystem expands (hereinafter referred to as a regeneration cycle) is realized.

The present technology realizes a regeneration cycle efficiently using livestock, and enables effective the desert greening and ecosystem regeneration.

### 2. Embodiment

FIG. 1 is a block diagram illustrating an embodiment of an information processing system 1 to which the present technology is applied.

An information processing system 1 is a system for performing the desert greening and ecosystem regeneration by causing a herd consisting of livestock 3-1 to 3-n to behave systematically and realizing a regeneration cycle. The livestock 3-1 to 3-n are grazing animals such as cows, horses, sheep, goats, and reindeer.

The livestock 3-1 to 3-n do not necessarily have to be one kind of animal, and two or more kinds of animals may be mixed.

In addition, hereinafter, when it is not necessary to distinguish the livestock 3-1 to 3-n individually, it is simply referred to as the livestock 3.

In addition, in the present specification, grazing also includes special forms of grazing such as nomadic grazing and transhumance.

The information processing system 1 includes a server 11, a mobile terminal 12, an information processing terminal 13, an animal terminal 14a-1 to an animal terminal 14a-n, and an animal terminal 14b. The server 11, the mobile terminal 12, the information processing terminal 13, the animal terminal 14a-1 to the animal terminal 14a-n, and the animal terminal 14b are connected to each other via a network 21 and are connected to each other and communicate with each other.

Hereinafter, when it is not necessary to individually distinguish the animal terminals 14a-1 to 14a-n, it is simply referred to as the animal terminal 14a. Further, when it is not necessary to individually distinguish the animal terminals 14a and 14b, it is simply referred to as the animal terminal 14.

The server 11 is owned by an organization (company, research institute, herd, and the like) that performs the desert greening and ecosystem regeneration by controlling the behavior of a herd of livestock 3, for example.

Hereinafter, a user who controls the behavior of a herd of livestock 3 using the server 11 is referred to as a leader.

The mobile terminal 12 is provided on the mobile object 2. The mobile object 2 is used for observing the state of a pasture land where the livestock 3 are grazing and the state of the livestock 3, and is configured of, for example, a flying object such as a drone, an airplane, or a helicopter.

An example of the case where the mobile object 2 is configured of a drone will be described below.

The information processing terminal 13 is configured of, for example, an information processing terminal such as a smartphone, a personal computer, or a tablet terminal. The information processing terminal 13 is owned by, for example, a user who grazes the livestock 3 (hereinafter, referred to as a pastor).

The animal terminal 14a is provided for each livestock 3.

The animal terminal 14b is provided on a herding dog 4. The herding dog 4 guides, watches, and protects a herd of livestock 3.

The server 11 observes the state of the pasture land, the state of the livestock 3, and the state around the livestock 3 based on, for example, the data transmitted from the mobile terminal 12, the information processing terminal 13, the animal terminal 14a, and the animal terminal 14b. The server 11 creates a behavior plan of a herd of livestock 3 based on, for example, at least one of the state of the pasture land, the state of the livestock 3, and the state around the livestock 3 so as to promote the regeneration cycle of the pasture land and contribute to the desert greening and ecosystem regeneration. Then, the server 11 controls the behavior of the herd of the livestock 3 so as to follow the behavior plan.

For example, the server 11 directly controls the behavior of each livestock 3 via the animal terminal 14a. Alternatively, the server 11 indirectly controls the behavior of each livestock 3 by giving an instruction to the pastor via the information processing terminal 13. Alternatively, the server 11 indirectly controls the behavior of each livestock 3 by controlling the behavior of the herding dog 4 via the animal terminal 14b.

Also, for example, the server 11 evaluates the degree of contribution of the herd of livestock 3 to the desert greening and ecosystem regeneration based on at least one of the state of the pasture land, the state of the livestock 3, and the state around the livestock 3. The server 11 sets a reward to be given to the pastor based on the degree of contribution of the herd of livestock 3. Then, the server 11 transmits the data related to the reward to the information processing terminal 13.

The information processing terminal 13 presents, for example, various pieces of data received from the server 11, the animal terminal 14a, and the animal terminal 14b to the pastor. Further, for example, the information processing terminal 13 transmits the data input by the pastor to the server 11, the animal terminal 14a, and the animal terminal 14b, as needed.

For example, the animal terminal 14a collects various pieces of data related to the state of the livestock 3 and the state around the livestock 3, and transmits the collected data to the server 11 and the information processing terminal 13 as needed. Further, for example, the animal terminal 14a controls the behavior of the livestock 3 under the control of the server 11.

The animal terminal 14b collects various pieces of data related to the state of the herding dog 4 and the state around the herding dog 4, and transmits the collected data to the server 11 and the information processing terminal 13 as needed. Further, for example, the animal terminal 14b controls the behavior of the herding dog 4 under the control of the server 11.

In addition, in FIG. 1, in order to facilitate the explanation, an exemplary configuration in which the behavior of one herd of livestock 3 is controlled is shown, but the number of herds of livestock that the information processing system 1 controls the behavior thereof is not particularly limited. The numbers of the server 11, the mobile object 2 and the mobile terminal 12, the information processing terminal 13, and the herding dog 4 and the animal terminal 14b may be set to any number of 2 or more.

### <Exemplary Configuration of Server 11>

FIG. 2 is a block diagram illustrating an exemplary functional configuration of the server 11 of FIG. 1.

The server 11 includes a CPU (Central Processing Unit) 101, a memory 102, a storage 103, an operation unit 104, a display unit 105, a speaker 106, a communication unit 107, an external I/F 108, and a drive 109. The CPU 101 to the drive 109 are connected to a bus and perform necessary communication with each other.

The CPU 101 performs various processes by executing a program installed in the memory 102 or the storage 103.

The memory 102 is configured of, for example, a volatile memory or the like, and temporarily stores a program executed by the CPU 101 and necessary data.

The storage 103 is configured of, for example, a hard disk or a non-volatile memory, and stores a program executed by the CPU 101 and necessary data.

The operation unit 104 is configured of physical keys (including a keyboard), a mouse, a touch panel, and the like. The operation unit 104 outputs an operation signal corresponding to the operation of the user (for example, a leader) to the bus in response to the operation of the user.

The display unit 105 is configured of, for example, an LCD (Liquid Crystal Display) or the like, and displays an image according to the data supplied from the bus.

Here, a touch panel as the operation unit 104 is configured of a transparent member and can be integrally configured with the display unit 105. As a result, the user (for example, a leader) can input information in a form of operating an icon, a button, or the like displayed on the display unit 105.

The speaker 106 outputs sound according to the data supplied from the bus.

The communication unit 107 includes a communication circuit, an antenna, and the like, and communicates with the mobile terminal 12, the information processing terminal 13, the animal terminal 14a, the animal terminal 14b, and the like via the network 21.

The external I/F (interface) 108 is an interface for exchanging data with various external devices.

The drive 109 is configured such that a removable recording medium 109A such as a memory card can be attached thereto and detached therefrom, and drives the removable recording medium 109A mounted therein.

In the server 11 configured as described above, the program executed by the CPU 101 can be recorded in advance in the storage 103 as a recording medium built in the CPU 101.

Further, the program can be stored (recorded) in the removable recording medium 109A, provided as so-called package software, and installed on the server 11 from the removable recording medium 109A.

In addition, the program can be downloaded from a server or the like (not shown) and installed on the server 11 via the network 21 and the communication unit 107.

By executing the program installed in the server 11, the CPU 101 can function as an observation unit 121, a planning unit 122, a guidance unit 123, an evaluation unit 124, a reward setting unit 125, and an output control unit 126.

The observation unit 121 observes the state of the pasture land, the state of each livestock 3, and the state around each livestock 3 based on, for example, the data transmitted from the mobile terminal 12, the information processing terminal 13, the animal terminal 14a, and the animal terminal 14b.

The planning unit 122 creates a behavior plan of the herd of livestock 3 based on, for example, at least one of the state of the pasture land and the state of each livestock 3 so as to promote the regeneration cycle of the pasture land and enhance the degree of contribution to the desert greening and ecosystem regeneration.

The guidance unit 123 guides each livestock 3 to behave according to the behavior plan via at least one of the information processing terminal 13, the animal terminal 14a, and the animal terminal 14b.

The evaluation unit 124 evaluates the behavior of the herd of livestock 3, specifically, the degree of contribution of the herd of livestock 3 to the desert greening or ecosystem regeneration, based on at least one of the state of the pasture land and the behavior of the herd of livestock 3.

The reward setting unit 125 sets a reward to be given to the pastor based on the degree of contribution of the herd of livestock 3 to the desert greening or ecosystem regeneration. Further, the reward setting unit 125 generates reward data related to the set reward and outputs the same to the bus.

The output control unit 126 controls the display of the image by the display unit 105 and the output of the sound by the speaker 106.

### <Exemplary Configuration of Mobile Terminal 12>

FIG. 3 is a block diagram illustrating an exemplary functional configuration of the mobile terminal 12 of FIG. 1.

The mobile terminal 12 includes a CPU 151, a memory 152, a storage 153, an operation unit 154, a display unit 155, a camera 156, a position detection unit 157, a communication unit 158, an external I/F 159, and a drive 160. The CPU 151 to the drive 160 are connected to the bus and perform necessary communication with each other.

The CPU 151 to the display unit 155, the external I/F 159, and the drive 160 are configured in the same manner as the CPU 101 to the display unit 105, the external I/F 108, and the drive 109 in FIG. 2, respectively.

The camera 156 is configured of, for example, a multi-spectral camera. The camera 156 captures an image (still image, moving image) (senses light) and outputs the corresponding image data to the bus.

The position detection unit 157 uses, for example, GNSS (Global Navigation Satellite System) to detect the position (for example, latitude, longitude, altitude) of the mobile terminal 12 as the position of the mobile object 2. The position detection unit 157 outputs position information indicating the detected position to the bus.

The communication unit 158 includes a communication circuit, an antenna, and the like, and communicates with the server 11, the information processing terminal 13, the animal terminal 14a, the animal terminal 14b, and the like via the network 21. As the communication method of the communication unit 158, a wireless communication method having low power consumption, for example, LPWA (Low Power Wide Area) or the like is adopted.

The mobile terminal 12 can be provided with a sensor other than the camera 156 that senses light, that is, a sensor 161 that senses a physical quantity different from that of the camera 156. The type and number of physical quantities sensed by the sensor 161 are arbitrary. For example, physical quantities such as weather, temperature, humidity, atmospheric pressure, acceleration, angular acceleration, geomagnetism, and sound are assumed. The sensor 161 outputs sensor data indicating the sensed physical quantity to the bus.

In the mobile terminal 12, similarly to the server 11, the program executed by the CPU 151 can be recorded in advance in the storage 153 as a recording medium built in the mobile terminal 12.

Further, the program can be stored (recorded) in the removable medium 160A, provided as package software, and installed on the mobile terminal 12 from the removable medium 160A.

In addition, the program can be downloaded from a server or the like (not shown) via the network 21 and the communication unit 158, and installed in the mobile terminal 12.

The CPU 151 can function as a data processing unit 171 and an output control unit 172 by executing a program installed in the mobile terminal 12.

The data processing unit 171 generates position data including the position information of the mobile terminal 12 (mobile object 2) detected by the position detection unit 157, and outputs the position data to the bus. Further, the data processing unit 171 generates observation data including information on the state of the pasture land observed by the camera 156 and the sensor 161 and outputs the observation data to the bus.

The output control unit 172 controls the display of the image by the display unit 155.

### <Exemplary Configuration of Information Processing Terminal 13>

FIG. 4 is a block diagram illustrating an exemplary functional configuration of the information processing terminal 13 of FIG. 1.

The information processing terminal 13 includes a CPU 201, a memory 202, a storage 203, an operation unit 204, a display unit 205, a speaker 206, a camera 207, a microphone 208, a position detection unit 209, a communication unit 210, an external I/F 211, a drive 212, and a sensor 213. The CPU 201 to the sensor 213 are connected to the bus and perform necessary communication with each other.

The CPU 201 to the display unit 205, the position detection unit 209, the external I/F 211, and the drive 212 are configured in the same manner as the CPU 151 to the display unit 155, the position detection unit 157, the external I/F 159, and the drive 160 in FIG. 3.

The speaker 206 outputs sound according to the data supplied from the bus.

The camera 207 is configured of, for example, an RGB camera. The camera 207 captures an image (still image, moving image) (senses light) and outputs the corresponding image data to the bus.

The microphone 208 collects the sound (senses the sound) and outputs the corresponding sound data to the bus.

The communication unit 210 includes a communication circuit, an antenna, and the like, and communicates with the server 11, the mobile terminal 12, the animal terminal 14a, the animal terminal 14b, and the like via the network 21.

The sensor 213 is configured of a camera 207 that senses light and a sensor other than the microphone 208 that senses sound, that is, a sensor that senses a physical quantity different from that of the camera 207 and the microphone 208. The type and number of physical quantities sensed by the sensor 213 are arbitrary. For example, physical quantities such as acceleration, angular acceleration, and geomagnetism are assumed. The sensor 213 outputs sensor data indicating the sensed physical quantity to the bus.

In the information processing terminal 13, similarly to the server 11, the program executed by the CPU 201 can be recorded in advance in the storage 203 as a recording medium built in the information processing terminal 13.

Further, the program can be stored (recorded) in the removable medium 212A, provided as package software, and installed in the information processing terminal 13 from the removable medium 212A.

In addition, the program can be downloaded from a server or the like (not shown) and installed in the information processing terminal 13 via the network 21 and the communication unit 210.

The CPU 201 can function as a data processing unit 271 and an output control unit 272 by executing a program installed in the information processing terminal 13.

The data processing unit 221 performs various processes on various pieces of data transmitted/received by the information processing terminal 13, image data output from the camera 156, sound data output from the microphone 208, position information output from the position detection unit 209, and the sensor data and the like output from the sensor 213.

The output control unit 222 controls the display of the image by the display unit 205 and the output of the sound by the speaker 206.

### <Exemplary Configuration of Animal Terminal 14>

FIG. 5 is a block diagram illustrating an exemplary functional configuration of the animal terminal 14 of FIG. 1.

The animal terminal 14 includes a CPU 251, a memory 252, a storage 253, an operation unit 254, a display unit 255, an earpiece 256, a camera 257, a position detection unit 258, a communication unit 259, an external I/F 260, and a drive 261. The CPU 251 to the drive 261 are connected to the bus and perform necessary communication with each other.

The CPU 251 to the display unit 255 and the camera 257 to the drive 261 are configured in the same manner as the CPU 151 to the display unit 155 and the camera 156 to the drive 160 in FIG. 3, respectively.

The earpiece 256 is attached to both ears of the livestock 3 or the herding dog 4. The earpiece 256 is configured of, for example, a sound conduit type earpiece that transmits sound directly to the eardrum through a sound conduit without blocking the ears. As a result, the discomfort felt by the livestock 3 and the herding dog 4 by wearing the earpiece 256 is reduced.

The earpiece 256 outputs sound according to the data supplied from the bus. This sound corresponds to, for example, virtual surround, and the position of the sound source (virtual sound source) felt by the livestock 3 or the herding dog 4 can be freely moved.

The animal terminal 14 can be provided with a sensor other than the camera 257 that senses light, that is, a sensor 262 that senses a physical quantity different from that of the camera 257. The type and number of physical quantities sensed by the sensor 262 are arbitrary. For example, physical quantities such as biological information (for example, body temperature, heartbeat, and the like) of the livestock 3 or the herding dog 4, weather, temperature, humidity, atmospheric pressure, odor, acceleration, angular acceleration, geomagnetism, sound, and the like are assumed. The sensor 262 outputs sensor data indicating the sensed physical quantity to the bus.

In the animal terminal 14, similarly to the server 11, the program executed by the CPU 251 can be recorded in advance in the storage 253 as a recording medium built in the animal terminal 14.

Further, the program can be stored (recorded) in the removable medium 261A, provided as package software, and installed on the animal terminal 14 from the removable medium 261A.

In addition, the program can be downloaded from a server or the like (not shown) and installed on the animal terminal 14 via the network 21 and the communication unit 259.

The CPU 251 can function as a data processing unit 271 and an output control unit 272 by executing a program installed in the animal terminal 14.

The data processing unit 271 generates position data including the position information of the animal terminal 14 (livestock 3 or herding dog 4) detected by the position detection unit 258, and outputs the position data to the bus. In addition, the data processing unit 271 generates observation data including information on the state of the livestock 3 or the herding dog 4 observed by the camera 257 and the sensor 262 and the state around the livestock 3 or the herding dog 4 and outputs the observation data to the bus.

The output control unit 272 controls the display of the image by the display unit 255 and the output of the sound by the earpiece 256.

It is desirable that the animal terminal 14 is operable by energy harvesting in order to eliminate the need for battery replacement.

### <Desert Greening and Ecosystem Regeneration Process>

Next, the desert greening and ecosystem regeneration process executed by the server 11 will be described with reference to the flowchart of FIG. 6.

In step S1, the observation unit 121 analyzes the current state.

Specifically, for example, the mobile object 2 flies over the pasture land, and the camera 156 of the mobile terminal 12 photographs the pasture land from the sky. The mobile terminal 12 supplies the observation data including the obtained image data to the server 11.

The method of supplying observation data from the mobile terminal 12 to the server 11 is not particularly limited. For example, the observation data is transmitted to the server 11 via the network 21 by the communication unit 158 of the mobile terminal 12. For example, the observation data is recorded on the removable medium 160A and supplied to the server 11 via the removable medium 160A.

The observation unit 121 of the server 11 uses vegetation indexes such as NDVI (Normalized Difference Vegetation Index) and VARI (Visible Atmospherically Resistant Index) to classify the pasture land into bare areas, green areas, and withered areas based on, for example, the image data of the pasture land. In this way, one aspect of the distribution of vegetation in the pasture land is observed.

The bare area is a land where both green grass and withered grass barely grow. The bare area is, for example, a land in which the ratio of the area where grass does not grow and the surface is exposed to the unit area is equal to or more than a predetermined threshold value.

The green area is a land where a lot of green grass grows. The green area is, for example, a land in which the ratio of the area where green grass grows per unit area is equal to or more than a predetermined threshold value.

The withered area is a land where a lot of withered grass grows. The withered area is, for example, a land in which the ratio of the area where withered grass grows to the unit area is equal to or more than a predetermined threshold value.

Further, the observation unit 121 may detect, for example, the growth process of the grass in the pasture land by comparing the image data of the pasture land in time series, and further classify the green area based on the detected growth process.

FIG. 7 illustrates an example of a grass growth curve. The horizontal axis of FIG. 7 illustrates time, and the vertical axis illustrates the height (plant height) of grass.

The grass grows in a sigmoid curve, for example, as shown in this example.

For example, the period A in FIG. 7 is a period immediately after the grass germinates and the grass grows slowly. Hereinafter, the period A is referred to as a germination period.

The period B is a period in which the growth rate of the grass is accelerated and the grass grows rapidly. Hereinafter, the period B is referred to as a growth period.

The period C is a period in which the growth of the grass tends to converge and the growth rate of the grass slows down. Hereinafter, the period C is referred to as a convergence period.

The period D is a period in which the growth of the grass converges and the growth of the grass stops (the grass matures). Hereinafter, the period D is referred to as a maturity period.

For example, the observation unit 121 classifies the green area into an area in which the grass in the germination period occupies the largest proportion (hereinafter referred to as a germination area), an area in which the grass in the growth period occupies the largest proportion (hereinafter referred to as a growth area), an area where the grass in the convergence period occupies the largest proportion (hereinafter referred to as a convergence area), and an area where the grass in the maturity period occupies the largest proportion (hereinafter referred to as a maturity area).

Further, the observation unit 121 classifies the pasture land into an area where soil capping has occurred and the surface has hardened (hereinafter referred to as a surface-hardened area) and an area where soil capping has not occurred and the surface is not hardened (hereinafter referred to as a non-surface-hardened area) based on the image data of the pasture land. In this way, one aspect of the distribution of soil in the pasture land is observed.

Further, the observation unit 121 uses vegetation indexes such as NDVI and VARI to classify the pasture land into an area where vegetation is observed (hereinafter, a vegetation area) and an area where vegetation is not observed (hereinafter, a non-vegetation area) based on the image data of the pasture land. In this way, one aspect of the distribution of vegetation in the pasture land is observed. Further, for example, the amount of biomass in the pasture land is calculated based on the ratio of the vegetation area per unit area.

In step S2, the planning unit 122 creates a behavior plan. Specifically, the planning unit 122 creates a behavior plan of the herd of livestock 3 based on the state of the pasture land and the state of the herd of livestock 3 so that the degree of contribution of the herd of livestock 3 to the desert greening and ecosystem regeneration is increased as high as possible. As the state of the perpendicular, for example, one or more of the result of the analysis of the current state of the pasture land obtained in step S1, the climate, the altitude, the type of growing grass and the like are used. As the state of the herd of livestock 3, for example, one or more of the type and number of livestock 3, the age, gender, size, weight and the like of each livestock 3 are used.

For example, the planning unit 122 creates a behavior plan of the herd of livestock 3 so as to satisfy at least one of the following conditions 1 to 5 as much as possible. The behavior plan includes, for example, the route on which the herd of livestock 3 moves, and the estimated arrival date and time at each checkpoint and goal on the route. This behavior plan defines the distance and speed of movement of the herd of livestock 3.

### Condition 1: Increase the consumption of Withered Grass

Livestock 3 prefers green grass to withered grass, so if left unattended, it will eat only green grass without eating withered grass. Then, green areas will decrease, withered areas and bare areas will increase, and desertification will progress. Therefore, it is desirable to increase the consumption of withered grass as much as possible and expand the environment in which plants can easily grow as much as possible by causing the livestock 3 to preferentially feed on the withered grass.

### Condition 2: Optimize the timing of feeding green grass

If the livestock 3 eats only withered grass, it may accumulate dissatisfaction, stress, and damage its health. Therefore, it is desirable to optimize the timing of feeding green grass to the livestock 3 so that the livestock 3 can eat green grass appropriately. In addition, it is desirable to give the livestock 3 an opportunity to eat the green grass as regularly as possible (for example, once a week) so that the period during which the livestock 3 cannot eat the green grass does not become too long.

When the distribution of grass types (plant species) in the pasture land can be observed using NDVI, VARI, or the like, the type of green grass preferred by the livestock 3 may be fed at an appropriate timing.

### Condition 3: Suppress the consumption of green grass until the growth period

Until the growth period (germination period and growth period), green grass is not yet fully grown, so it is short and small in quantity. Therefore, when the livestock 3 feeds on the green grass until the growth period, the amount of the green grass consumed increases and the area where the green grass is consumed increases. On the other hand, the green grass after the convergence period (convergence period and maturity period) is tall and abundant because it is sufficiently grown. Therefore, when the livestock 3 feeds on the green grass after the convergence period, the amount of the green grass consumed decreases and the area where the green grass is consumed becomes narrow. Therefore, it is desirable to cause the livestock 3 to preferentially feed on the green grass after the convergence period so as to suppress the consumption of the green grass until the growth period.

Further, for example, it is desirable to feed the livestock 3 preferentially on the green grass in the convergence period rather than the green grass in the maturity period. As a result, the cycle in which new plants grow can be shortened, and the regeneration cycle can be accelerated.

The condition 3 is applied in combination with the condition 2, for example.

### Condition 4: Extend the distance traveled within the surface-hardened area as much as possible

As described above, when the herd of livestock 3 moves in the surface-hardened area, the surface of the surface-hardened area is smoothed by the hoofs of the livestock 3 and fertilized by the manure of the livestock 3, and the soil of the surface-hardened area is regenerated. Therefore, it is desirable to extend the distance that the herd of livestock 3 travels within the surface-hardened area as much as possible. For example, it is desirable that the herd of livestock 3 moves preferentially in the surface-hardened area and does not move in the same place in the surface-hardened area in an overlapping manner. It is also desirable that the herd of livestock 3 move as quickly as possible within the surface-hardened area.

In addition, it is necessary to move the livestock 3 only within the surface-hardened area (particularly bare areas) so that there is no shortage of opportunities to eat food.

### Condition 5: Suppress the dispersion of the herd of livestock 3

As described above, when the herd of livestock 3 moves through the withered area, they eat the withered grass and knock down the withered grass. At this time, if the herd of livestock 3 is crowded, the withered grass in the over-resting state almost disappears in the area where the herd of livestock 3 has passed (hereinafter referred to as a passing area), and new plants are likely to grow. On the other hand, when the herd of livestock 3 is dispersed, the withered grass in the over-resting state remains as it is in the passing area, and the area where it is difficult for new plants to grow remains. Therefore, it is desirable to suppress the dispersion of the herd of livestock 3 and move the herd of livestock 3 as crowded as possible.

The planning unit 122 may give a priority to the conditions 1 to 5 and create a behavior plan with priority given to the condition having a high priority.

Further, any method can be used as a method for the planning unit 122 to create a behavior plan of the herd of livestock 3.

For example, by machine learning such as deep learning, a classifier that creates a behavior plan that satisfies the above conditions as much as possible based on the feature amounts of the herd of livestock 3 and the pasture land may be generated and applied to the planning unit 122. That is, the planning unit 122 may create a behavior plan of the herd of livestock 3 based on the feature amounts of the herd of livestock 3 and the pasture land, and the like, using the classifier obtained by machine learning.

As the feature amount of the herd of livestock 3, for example, the type and number of livestock 3, the age, sex, size, weight and the like of each livestock 3 are assumed. As the feature amount of the grass, in addition to the distribution of the pasture land obtained by the above-mentioned analysis process, the climate of the pasture land, the altitude, the type of grass growing in the pasture land, and the like are assumed.

Further, for example, the planning unit 122 may create a behavior plan that satisfies the above conditions as much as possible using a predetermined function or algorithm based on the feature amounts of the herd of livestock 3 and the pasture land.

For example, the planning unit 122 may create a plurality of behavior plans and let the leader select a behavior plan.

Further, for example, the leader may create a behavior plan so as to satisfy the above conditions as much as possible based on the feature amounts of the herd of livestock 3 and the pasture land, and input the data indicating the created behavior plan to the server 11.

In step S3, the server 11 guides the herd of livestock 3 according to the behavior plan.

Specifically, the observation unit 121 collects data related to the state of each livestock 3 and the state around each livestock 3 from the animal terminal 14a of each livestock 3 as necessary, and observes the state of each livestock 3 and the state around each livestock 3.

For example, the position detection unit 258 of the animal terminal 14a of each livestock 3 detects the current position, which is one of the states of the livestock 3, at a predetermined sampling interval. The data processing unit 271 of the animal terminal 14a generates position data including the position information of the livestock 3. The communication unit 259 of the animal terminal 14a transmits the position data to the server 11.

The observation unit 121 of the server 11 acquires position data from each animal terminal 14a via the network 21 and the communication unit 107. For example, the observation unit 121 observes the position, speed, moving direction, trajectory, and the like of each livestock 3 based on the acquired position data. Further, the observation unit 121 calculates dispersion σ²(t) of the herd of the livestock 3 at the sampling date and time t by the following equation (1) based on the position of each livestock 3.

$${σ}^{2} \left(\text{t}\right) = {\sum }_{\text{i} = 1}^{\text{n}} \frac{{\left\{{\text{x}}_{\text{i}} \left(\text{t}\right) - {\text{x}}_{\text{av}} \left(\text{t}\right)\right\}}^{2}}{\text{n}} \qquad \text{[Math. 1]}$$

xᵢ(t) indicates the position of livestock 3-i at the date and time t. xₐᵥ(t) indicates the average of the positions xᵢ(t) of the livestock 3-1 to 3-n at the date and time t. Therefore, the dispersion σ²(t) of the herd of livestock 3 is the dispersion of the positions xᵢ(t) of the livestock 3-1 to 3-n at the date and time t.

If the sampling period of the position data of each livestock 3 is shortened, the detection accuracy is improved, but the power consumption of the animal terminal 14a is increased. On the other hand, if the sampling period is lengthened, the power consumption of the animal terminal 14a is reduced, but the detection accuracy is lowered. Therefore, it is desirable to appropriately set the sampling period based on the mobility of the livestock 3 and the like. For example, when the livestock 3 is a cow, the cow does not move much, so the sampling period is set to, for example, one hour.

Further, in order to further reduce the power consumption, for example, the position detection unit 258 of each animal terminal 14a may transition to a sleep state during the period when the current position is not detected.

However, if the sleep time becomes too long, the deviation from the real time of the RTC (Real Time Clock) timer included in the position detection unit 258 becomes large, and the time required to capture the GNSS signal when the position detection unit 258 is activated may become long.

On the other hand, for example, the position detection unit 258 may perform tracking of the GNSS satellite in a period shorter than the sampling period of the position data.

Further, for example, when there is an enough storage area in the animal terminal 14a, the position detection unit 258 may detect the current position in a period shorter than the sampling period, record the detected current position, and perform interpolation processing of the current position as needed. In this case, the reliability of the current position may be calculated based on the capturing state of the GNSS signal, and the current position may be weighted based on the reliability to perform the interpolation processing.

Further, for example, the camera 257 of each animal terminal 14a takes pictures at a predetermined sampling interval, and the sensor 262 performs sensing at a predetermined sampling interval. The data processing unit 271 of the animal terminal 14a generates observation data including information on the state of the livestock 3 or the state around the livestock 3 based on the image data supplied from the camera 257 and the sensor data supplied from the sensor 262. The communication unit 259 of the animal terminal 14a transmits the observation data to the server 11.

The observation unit 121 of the server 11 acquires observation data from each animal terminal 14a via the network 21 and the communication unit 107. The observation unit 121 observes the state of each livestock 3 and the state around each livestock 3 based on the acquired observation data.

The type of the state of each livestock 3 to be observed and the type of the state around each livestock 3 are set as necessary. For example, as the state of each livestock 3, biological information (for example, body temperature, heartbeat, and the like), posture, type of grass being eaten, and the like can be observed. In addition, as the state around each livestock 3, for example, weather, temperature, temperature, atmospheric pressure, odor, soil condition, vegetation type, plant growth condition, type of existing organism, presence/absence, position, and type of foreign enemies of livestock 3, and the like can be observed.

Further, information included in the observation data generated by the data processing unit 271 of each animal terminal 14a is set according to the observation target of the observation unit 121.

In order to reduce the power consumption of the animal terminal 14a, it is desirable to reduce the amount of observation data. For example, it is desirable not to include the image data or the sensor data as it is in the observation data, but to include the information extracted from the image data or the sensor data in the observation data. For example, instead of image data, it is desirable to perform object recognition on image data and include information indicating the type of recognized object in the observation data.

Further, in order to reduce the power consumption of the animal terminal 14a, it is desirable to set the sampling period of the observation data to an appropriate interval as well as the position data.

In addition, for example, each animal terminal 14a may collect data related to an observation target that does not need to be observed in real time to some extent (for example, after collecting data for one day) and then transmit the same to the server 11.

Further, each animal terminal 14a may store, for example, observation data that is not necessary for guiding the herd of livestock 3 in the storage 253 or the like without transmitting the same to the server 11 and read the same when necessary.

Further, the observation unit 121 collects, as needed, observation data including position data indicating the current position, which is one of the states of the herding dog 4, and data related to the state of the herding dog 4 and the state around the herding dog 4 from the animal terminal 14b of the herding dog 4, and observes the state of the herding dog 4 and the state around the herding dog 4. In addition, this processing is performed by the same method as the case of collecting and observing the data related to the state of each livestock 3 and the state around each livestock 3 described above.

Further, the type of the state of the herding dog 4 to be observed by the observation unit 121 and the type of the state around the herding dog 4 are set as necessary. For example, as the state of the herding dog 4, biological information (for example, body temperature, heartbeat, and the like) and the like can be observed. Further, for example, as the state around the herding dog 4, for example, the weather, the temperature, the temperature, the atmospheric pressure, the odor, the state of the surrounding livestock 3, the presence/absence, position, and type of foreign enemies of the livestock 3, and the like can be observed.

Further, the information included in the observation data generated by the data processing unit 271 of the animal terminal 14b is set according to the observation target of the observation unit 121.

Further, it is desirable to reduce the amount of observation data in order to reduce the power consumption of the animal terminal 14b, similarly to the observation data of the animal terminal 14a of each livestock 3 described above.

Further, in order to reduce the power consumption of the animal terminal 14b, it is desirable to set the sampling period of the position data and the observation data to an appropriate interval.

Further, the animal terminal 14b may, for example, collect data related to observation targets that do not need to be observed in real time to some extent (for example, after collecting data for one day) and then transmit the data to the server 11.

Further, for example, the animal terminal 14b may store observation data that is not necessary for guiding the herd of livestock 3 or the herding dog 4 in the storage 253 or the like without transmitting the same to the server 11, and read the same when necessary.

Further, for example, the mobile object 2 flies over the pasture land to observe the state of the pasture land, the state of the livestock 3, and the state around the livestock 3 as needed. Then, as in the process of step S1, the camera 156 of the mobile terminal 12 photographs the pasture land from the sky, and the mobile terminal 12 supplies the obtained image data to the server 11.

The observation unit 121 of the server 11 observes the state of the pasture land, the state of the livestock 3, and the state around the livestock 3 based on the acquired image data.

As the state of the pasture land, for example, the vegetation status, the distribution of vegetation, the vegetation index, the distribution of soil and the like can be observed. As the state of the livestock 3, for example, the position, speed, moving direction, dispersion, and the like of each livestock 3 can be observed. As the state around the livestock 3, for example, the surrounding vegetation status, the presence/absence, type, and position of foreign enemies, and the like can be observed.

The guidance unit 123 guides each livestock 3 as necessary based on the state of each livestock 3, the state around each livestock 3, and the state of the pasture land. For example, the guidance unit 123 guides each livestock 3 when a problem occurs in the herd of livestock 3, for example, when the herd of livestock 3 is dispersed or when the herd of livestock 3 does not behave according to the behavior plan.

The guidance unit 123 does not necessarily guide all livestock 3, but guides only livestock 3 that need to be guided, for example, the livestock 3 that are out of the herd or the livestock 3 that do not behave according to the behavior plan.

Here, a method for guiding the livestock 3 will be described. As a method of guiding the livestock 3 by the server 11, for example, there are a method of directly guiding the livestock 3 and a method of indirectly guiding the livestock 3. Further, as a method of indirectly guiding the livestock 3, for example, there are a method of guiding the livestock by the herding dog 4 and a method of guiding the livestock by the pastor.

### (Guidance Method 1)

In the first guidance method, the server 11 directly guides the livestock 3 via each animal terminal 14a.

For example, the guidance unit 123 generates sound data (hereinafter, referred to as guidance sound data) corresponding to a guidance sound for causing the guiding target livestock 3 to perform a desired behavior. The communication unit 107 transmits the guidance sound data to the animal terminal 14b of the guiding target livestock 3 via the network 21.

On the other hand, the communication unit 259 of the animal terminal 14b receives the guidance sound data and supplies the same to the CPU 251. The output control unit 272 outputs a guidance sound from the earpiece 256 based on the guidance sound data.

As a result, the livestock 3 is guided to perform a desired behavior according to the guidance sound output from the earpiece 256.

Here, an example of the guidance sound for the livestock 3 will be described.

For example, using the guidance sound corresponding to the virtual surround, the position of the virtual sound source of the guidance sound with respect to the livestock 3 can be freely moved. That is, the position of the sound source of the guidance sound felt by the livestock 3 can be freely moved.

Therefore, for example, a sound simulating a state in which a foreign enemy (for example, a carnivore) of the livestock 3 approaches from a direction opposite to the direction in which the livestock 3 is desired to be moved is used as a guidance sound. For example, when it is desired to move the livestock 3 in the north direction, a sound simulating a state in which a foreign enemy of the livestock 3 approaches from the south direction is used as a guidance sound. This guided sound includes, for example, a sound simulating the bark (bark), footsteps, and the like of a foreign enemy. As a result, the livestock 3 is guided to move in a desired direction in an unmanned manner.

Further, for example, by controlling the distance of the virtual sound source of the guidance sound to the livestock 3, the speed of the behavior of the livestock 3 can be controlled. For example, when it is desired to move the livestock 3 gently, the position of the virtual sound source may be set so that the bark of the foreign enemy can be heard from a distance (so that the bark can be heard). On the other hand, when it is desired to move the livestock 3 quickly or to limit the direction in which the livestock 3 moves, for example, the position of the virtual sound source may be set so that the bark of a foreign enemy can be heard from nearby.

As a result, each livestock 3 can be guided closer to each other more naturally.

Further, for example, a sound simulating the cry (for example, bark) of the herding dog 4 that drives the livestock 3 to move in a desired direction is used as the guidance sound. For example, when it is desired to move the livestock 3 in the north direction, a sound simulating the bark of the herding dog 4 driving the livestock 3 from the south direction is used as a guidance sound. As a result, the livestock 3 is guided to move in a desired direction in an unmanned manner.

Further, for example, a sound simulating the voice of a person (for example, a pastor) who guides the livestock 3 to perform a desired behavior is used as the guidance sound. As a result, the livestock 3 is guided to perform a desired behavior in an unmanned manner.

It is desirable that this guidance sound is close to the voice of the pastor.

Further, for example, a sound simulating a conversation sound for guiding the livestock 3 to perform a desired behavior, that is, a conversation sound (communication sound) for the livestock 3 to communicate with each other is used as the guidance sound. As a result, As a result, the livestock 3 is guided to perform the desired behavior in an unmanned manner.

The conversation sound of the livestock 3 is learned in advance by machine learning or the like.

Further, for example, a trigger sound, which is a sound preliminarily conditioned so that the livestock 3 performs various behaviors, is used as the guidance sound. As a result, the livestock 3 is guided to perform the desired behavior in an unmanned manner.

The trigger sound can be learned in advance by the livestock 3 by repeatedly listening to the trigger sound each time the livestock 3 starts various behaviors. For example, as a trigger sound, a sound for notifying the wake-up time, a sound for notifying the time to return to a predetermined place, a sound for notifying the start of a break, a sound for notifying the end of the break, a pitch sound for controlling the moving speed of the livestock 3, and the like are assumed.

Using the guidance sound in this way, the livestock 3 can be guided without causing physical pain to the livestock 3 such as an electric shock, for example. Further, since the guidance sound is output via the earpiece 256 worn by each livestock 3, each livestock 3 can be guided individually.

### (Guidance Method 2)

In the second guidance method, the server 11 indirectly guides the livestock 3 by guiding the herding dog 4 via the animal terminal 14b. That is, the server 11 guides the herding dog 4 so as to guide the livestock 3 via the animal terminal 14b.

For example, the guidance unit 123 generates guidance sound data corresponding to the guidance sound that guides the herding dog to cause the livestock 3 to perform a desired behavior. The communication unit 107 transmits the guidance sound data to the animal terminal 14b via the network 21.

On the other hand, the communication unit 259 of the animal terminal 14b receives the guidance sound data and supplies the same to the CPU 251. The output control unit 272 outputs the guidance sound from the earpiece 256 based on the guidance sound data.

As a result, the herding dog 4 is guided to cause the livestock 3 to perform a desired behavior according to the guidance sound output from the earpiece 256. That is, the herding dog 4 guides the livestock 3 to perform a desired behavior.

Here, an example of the guidance sound for the herding dog 4 will be described.

For example, the herding dog 4 is trained in advance to guide each livestock 3 to perform various behaviors according to a command from the pastor. Specifically, for example, the herding dog 4 is trained to drive the livestock 3 in the instructed direction according to a command from the pastor.

Therefore, for example, a sound simulating the command of the voice of a person who guides the herding dog 4 to cause the livestock 3 to perform a desired behavior is used as the guidance sound. As a result, the herding dog 4 guides the livestock 3 to perform a desired behavior in an unmanned manner.

It is desirable that this guidance sound is close to the voice of the pastor.

### (Guidance Method 3)

In the third guidance method, the server 11 indirectly guides the herd of livestock 3 by guiding the pastor via the information processing terminal 13. That is, the server 11 guides the pastor to guide the herd of the livestock 3 according to the behavior plan via the information processing terminal 13.

For example, the guidance unit 123 of the server 11 generates guidance data for guiding the pastor to cause the herd of livestock 3 to behave according to the behavior plan. The guidance data includes, for example, information such as a behavior plan of the herd of livestock 3 and a reward for the pastor. The communication unit 107 transmits guidance data to the information processing terminal 13 via the network 21.

On the other hand, the communication unit 210 of the information processing terminal 13 receives the guidance data and supplies the same to the CPU 201. The output control unit 222 causes the display unit 205 to display information such as a behavior plan and a reward based on the guidance data.

On the other hand, the pastor guides the herd of livestock 3 to behave according to the presented behavior plan.

Here, for example, as will be described later, by setting the reward to the pastor according to the degree of contribution of the herd of livestock 3 to the desert greening and ecosystem regeneration, it is possible to improve the motivation of the pastor to guide the herd of livestock 3 according to the behavior plan.

For example, as in the guidance method 1 and the guidance method 2, the server 11 may guide the pastor via the information processing terminal 13 as necessary when a problem occurs in the herd of livestock 3.

For example, when a problem occurs in the herd of livestock 3, the guidance unit 123 generates guidance data for guiding (instructing) the pastor to guide the livestock 3 and solve the problem. The guidance data includes, for example, information such as the content of the problem that has occurred and the solution of the problem. The communication unit 107 transmits guidance data to the information processing terminal 13 via the network 21.

On the other hand, the communication unit 210 of the information processing terminal 13 receives the guidance data and supplies the same to the CPU 201. The output control unit 222 causes the display unit 205 to display information such as the content of the problem that has occurred and the solution of the problem based on the guidance data.

The pastor then guides the herd of livestock 3 so as to solve the problem according to the information presented.

As a result, it is possible to quickly solve the problem that has occurred in the herd of livestock 3.

It is possible to combine two or more of the above guidance methods 1 to 3.

For example, the guidance method 1 and the guidance method 2 may be combined so that the server 11 guides both the livestock 3 and the herding dog 4.

For example, by combining the guidance method 1 and the guidance method 3, the pastor basically guides the livestock 3, but the server 11 may guide the livestock 3 as needed in an emergency or the like.

During execution of the process of step S3, the flow may return to the process of step S1 and step S2, as necessary, the current state of the pasture land may be analyzed, and the behavior plan may be corrected based on the result of the current state analysis.

In step S4, the evaluation unit 124 evaluates the behavior of the herd of livestock 3. For example, the evaluation unit 124 calculates the degree of contribution of the behavior of the herd of livestock 3 to the desert greening or ecosystem regeneration as a concrete numerical value during a predetermined evaluation target period.

Here, an example of a method for evaluating the degree of contribution will be described.

### (Evaluation Method 1)

In the first evaluation method, the degree of contribution is evaluated based on the behavior content of the herd of livestock 3 during the evaluation target period.

For example, it is assumed that the longer the moving distance of the herd of livestock 3, the larger the area where the soil is regenerated due to the passage of the livestock 3, and the greater the degree of contribution to the desert greening and ecosystem regeneration.

Therefore, for example, the longer the moving distance of the herd of livestock 3 during the evaluation target period, the higher the degree of contribution is set, and the shorter the moving distance of the herd of livestock 3 during the evaluation target period, the lower the degree of contribution is set.

The moving distance of the herd of livestock 3 during the evaluation target period is obtained by, for example, the integrated value of the moving distance of each livestock 3 during the evaluation target period.

However, even if each livestock 3 repeatedly moves in the same place, the degree of contribution (effect of) to the desert greening and ecosystem regeneration in that place does not change much. Therefore, the distance traveled in the same place may be subtracted from the moving distance of each livestock 3.

In addition, even if the herd of livestock 3 moves within the non-surface-hardened area, it does not contribute much to the desert greening and ecosystem regeneration. Therefore, the moving distance of the herd of the livestock 3 may be calculated only for the distance that each livestock 3 has moved within the surface-hardened area.

Here, as described above, when the herd of livestock 3 moves in a dispersed manner, the amount of the withered grass in the over-resting state increases without being knocked down in the passing area through which the herd of livestock 3 has passed. Therefore, the degree of contribution may be evaluated in consideration of the dispersion of the herd of livestock 3 in motion in addition to the moving distance of the herd of livestock 3. For example, the degree of contribution is calculated by the following equation (2).

$$\begin{matrix}\text{Degree of contribution} = \\ \left(\text{Movement of herd of livestock 3}\right) / \left(\text{dispersion} {\text{σ}}^{2} \text{of the}\right) \\ \left(\text{herd of livestock 3}\right)\end{matrix} \qquad \text{(2)}$$

The dispersion σ² of the herd of livestock 3 is calculated by the following equation (3).

$${σ}^{2} = \frac{{\int }_{0}^{\text{T}} {σ}^{2} \left(\text{t}\right) \text{dt}}{\text{T}} \qquad \text{[Math. 2]}$$

The dispersion σ²(t) of the herd of livestock 3 at the sampling date and time t in the equation (3) is calculated by the above-mentioned equation (1). Time T indicates the length of the evaluation target period.

In this case, the smaller the dispersion σ² of the herd of livestock 3, the higher the degree of contribution, and the larger the dispersion σ² of the herd of livestock 3, the lower the degree of contribution.

In addition, it is assumed that it is difficult to move livestock 3 in high places, and it is difficult to carry out the desert greening and ecosystem regeneration. Therefore, the degree of contribution may be calculated by taking into account the height difference of the route on which the herd of livestock 3 has moved during the evaluation target period. For example, the degree of contribution is calculated by the following equation (4).

$$\begin{matrix}\text{Degree of contribution} = \\ \left(\left(\text{Movement of herd of livestock 3}\right) \times \text{K}\right) / \left(\text{Dispersion} {\text{σ}}^{2} \text{of}\right) \\ \left(\text{herd of livestock 3}\right)\end{matrix} \qquad \text{(4)}$$

The coefficient K is a coefficient that increases as the height difference of the route traveled by the herd of livestock 3 increases.

### (Evaluation Method 2)

In the second evaluation method, the degree of contribution is evaluated by comparing the behavior plan of the herd of livestock 3 during the evaluation target period with the actual behavior content of the herd of livestock 3.

For example, the degree of contribution is evaluated by comparing the planned route of the herd of livestock 3 with the route (hereinafter referred to as an actual route) on which the herd of livestock 3 has actually moved.

For example, the closer the actual route is to the planned route, the higher the degree of contribution to the desert greening and ecosystem regeneration is expected. Therefore, for example, the smaller the difference between the planned route and the actual route, the higher the degree of contribution is set, and the larger the difference between the planned route and the actual route, the lower the degree of contribution is set.

It should be noted that not only the route but also the time factor may be taken into consideration when evaluating the degree of contribution. For example, the estimated arrival date and time at each checkpoint and goal on the planned route is compared with the actual arrival date and time, and the smaller the difference, the higher the degree of contribution is set, and the larger the difference, the lower the degree of contribution is set.

### (Evaluation Method 3)

In the third evaluation method, the degree of contribution is evaluated based on the state of the passing area through which the herd of livestock 3 has passed during the evaluation target period.

For example, the degree of contribution is evaluated based on an index (hereinafter referred to as a state index) indicating at least one state of soil and vegetation in the passing area.

For example, the amount of biomass is used as a state index. For example, the larger the amount of biomass in the passing area, the higher the degree of contribution is set, and the smaller the amount of biomass in the passing area, the lower the degree of contribution is set.

For example, the area of the surface-hardened area is used as the state index. For example, the smaller the area of the surface-hardened area in the passing area, the higher the degree of contribution is set, and the wider the area of the surface-hardened area in the passing area, the lower the degree of contribution is set.

It should be noted that the degree of contribution may be evaluated by combining a plurality of state indexes.

Further, for example, the degree of contribution may be evaluated by comparing the state of the passing area before the passage of the herd of livestock 3 with the state of the passing area after the passage.

For example, the degree of contribution is evaluated based on the amount of increase in the amount of biomass in the passing area after passage of the herd of livestock 3 with respect to the amount of biomass in the passing area before the passage. For example, the larger the increase in the amount of biomass in the passing area, the higher the degree of contribution is set, and the smaller the increase in the amount of biomass in the passing area, the lower the degree of contribution is set.

For example, the degree of contribution is evaluated based on the amount of decrease in the area of the surface-hardened area in the passing area after passage of the herd of livestock 3 with respect to the area of the surface-hardened area in the passing area before the passage. For example, the larger the decrease in the area of the surface-hardened area in the passing area, the higher the degree of contribution is set, and the smaller the decrease in the area of the surface-hardened area in the passing area, the lower the degree of contribution is set.

In this case as well, the degree of contribution may be evaluated by combining a plurality of state indexes.

Further, for example, the degree of contribution may be evaluated by comparing the state of the passing area with the state of the area around the passing area (hereinafter referred to as a non-passing area).

For example, the degree of contribution is evaluated based on the amount of increase in the amount of biomass in the passing area with respect to the amount of biomass in the non-passing area. For example, the larger the increase in the amount of biomass in the passing area, the higher the degree of contribution is set, and the smaller the increase in the amount of biomass in the passing area, the lower the degree of contribution is set.

For example, the degree of contribution is evaluated based on the amount of decrease in the proportion of the surface-hardened area in the passing area to the proportion of the surface-hardened area in the non-passing area. For example, the greater the decrease in the proportion of the surface-hardened area in the passing area, the higher the degree of contribution is set, and the smaller the decrease in the proportion of the surface-hardened area in the passing area, the lower the degree of contribution is set.

In this case as well, the degree of contribution may be evaluated by combining a plurality of state indexes.

It should be noted that two or more of the above evaluation methods 1 to 3 may be combined to evaluate the degree of contribution. For example, in the second method, the degree of contribution may be evaluated in consideration of the dispersion of the herd of livestock 3 in motion.

The state index of the passing area can be detected, for example, by the same process as in step S1 described above.

The state index of the passing area may be detected based on the observation data collected from the animal terminal 14a of each livestock 3.

For example, the amount of biomass per unit area of the passing area can be calculated using a function proportional to Tg/d.

Here, Tg is an integrated value of the time during which the herd of livestock 3 was eating grass during the evaluation target period. For example, Tg is an integrated value of the time each livestock 3 was eating grass during the evaluation target period. d is the distance traveled by the herd of livestock 3 during the evaluation target period. For example, d is the average distance traveled by each livestock 3 during the evaluation target period.

The time during which the livestock 3 was eating grass during the evaluation target period is estimated based on, for example, the detection result of the posture of the livestock 3. For example, the integrated value of the time during which the livestock was in the posture estimated to be eating grass is estimated as the time when the livestock 3 was eating grass.

Further, for example, the amount of biomass per unit area of the passing area may be calculated in consideration of the width Width in which the livestock 3 eats grass. For example, the amount of biomass per unit area of the passing area may be calculated using a function proportional to Tg/(Width × d). When the livestock 3 is a cattle, the Width is set to, for example, 30 cm.

Further, for example, the pasture land may be divided into a plurality of areas in a mesh shape, it may be determined whether or not each area is grazing (whether or not grass is eaten), and the amount of biomass may be evaluated by the number of grazing areas. The determination as to whether or not the grazing is performed may be made automatically based on, for example, an image of the pasture land taken from the mobile object 2 or the like, or may be visually determined by the pastor or the like.

Further, for example, a model for calculating the degree of contribution may be generated using machine learning such as deep learning and applied to the evaluation unit 124.

Furthermore, the degree of contribution may be calculated using big data including various pieces of data related to the state of the passing area and the area around the passing area, and the behavior of the herd of livestock 3 during the evaluation target period.

In step S5, the reward setting unit 125 sets the reward.

For example, the reward setting unit 125 sets the reward to be given to the pastor based on the degree of contribution calculated in the process of step S4. For example, the reward setting unit 125 increases the reward to be given to the pastor as the degree of contribution of the herd of livestock 3 increases, and decreases the reward to be given to the pastor as the degree of contribution of the herd of livestock 3 decreases. The reward setting unit 125 generates reward data indicating the set reward. The communication unit 107 transmits the reward data to the information processing terminal 13.

The output control unit 222 of the information processing terminal 13 receives reward data via the network 21 and the communication unit 210. The display unit 205 presents the reward to the pastor based on the reward data under the control of the output control unit 222.

At this time, the reward setting unit 125 may include the degree of contribution and its basis (for example, a calculation formula, an evaluation index, and the like) in the reward data. As a result, the presentation of the reward and the basis of the reward to the pastor is controlled.

The method of giving the reward to the pastor is not particularly limited. For example, the reward may be given by digital data such as electronic money or electronic coupon, or the reward may be given by physical money by bank transfer or cash handing.

This motivates pastors to cause the herd of livestock 3 to behave so that the degree of contribution to the desert greening and ecosystem regeneration increases. As a result, for example, the desert greening and ecosystem regeneration will be carried out efficiently, and the regeneration cycle will be accelerated.

The processing of steps S4 and S5 may be performed after the end of the period in which the behavior plan is set, or may be performed periodically during the period in which the behavior plan is set (for example, every January or March or every six-month period). In the latter case, the degree of contribution of the herd of livestock 3 is periodically evaluated and a reward is set while the herd of livestock 3 is being guided according to the behavior plan.

Further, for example, the progress of the degree of contribution of the herd of livestock 3 may be presented to the pastor on a regular basis (for example, every sampling, every hour, every day, every week, and the like) together with the ground thereof. This improves the motivation of the pastor.

For example, when the above-mentioned guidance method 3 is not used and the pastor is not involved in the guidance of the herd of livestock 3, the reward to the pastor may be constant regardless of the degree of contribution.

After that, the process returns to step S1, and the processes of steps S1 to S5 are repeatedly executed.

If necessary, the result of the process of step S4 may be used in the process of analyzing the current state of the pasture land in step S1.

As described above, it becomes possible to effectively perform the desert greening and ecosystem regeneration using the livestock 3.

For example, since the degree of contribution of the herd of livestock 3 to the desert greening and ecosystem regeneration is clearly shown according to predetermined standards, the behavior plan of the herd of livestock 3 with respect to the desert greening and ecosystem regeneration and the evaluation of the behavior plan of the herd of livestock 3 can be made easily. In addition, since the pastor’s reward is given based on the degree of contribution, the pastor is motivated to increase the degree of contribution and becomes actively involved in the desert greening and ecosystem regeneration. By controlling the behavior of the herd of livestock 3 so that the degree of contribution is higher, the desert greening and ecosystem regeneration are efficiently performed, desertification of pasture land is suppressed, and the regeneration cycle of the pasture land is accelerated. In addition, the desert greening and ecosystem regeneration can be realized without using measures other than the conventional grazing of the herd of livestock 3.

### 3. Modified Examples

Hereinafter, modified examples of the above-described embodiments of the present technology will be described.

### <Modified Example of Configuration of Information Processing System 1>

The configuration of the information processing system 1 of FIG. 1 can be changed as needed.

For example, the information processing terminal 13 can perform a part or all of the processes of the server 11.

Specifically, for example, the information processing terminal 13 may control transmission of guidance sound data to each animal terminal 14a or animal terminal 14b based on the observation results of the state of the livestock 3 and the state around the livestock 3 obtained by the server 11 and perform guidance of each livestock 3 or the herding dog 4. Further, for example, the information processing terminal 13 may acquire position data and observation data from each animal terminal 14a and animal terminal 14b, and observe the state of each livestock 3 and the state around each livestock 3.

Further, for example, the information processing terminal 13 may transmit guidance sound data to the animal terminal 14a or the animal terminal 14b according to the operation of the pastor, for example, and guide each livestock 3 or the herding dog 4.

Further, for example, when the herding dog 4 is not used for guiding the herd of livestock 3, the animal terminal 14b can be omitted.

Further, for example, instead of the image taken from the mobile object 2, or together with the image, an image taken from an artificial satellite may be used to observe the state of the pasture land.

Further, for example, it is possible to use a bird instead of the mobile object 2 or together with the mobile object 2. For example, a camera may be attached to a bird and the camera may be used to photograph the pasture land from the sky above the pasture land.

Further, for example, each animal terminal 14a does not necessarily have to be connected to the network 21. For example, each animal terminal 14a may be configured by a GNSS tracker or the like, and position data or the like may be stored in each animal terminal 14a. Then, for example, the information processing terminal 13 may be connected to each animal terminal 14a by a cable or the like, the information processing terminal 13 may read the accumulated position data or the like from each animal terminal 14a, and transmit the same to the server 11 via the network 21.

### <Modified Example of Internal Observation of Ecosystem>

For example, it is possible to observe the habits of the livestock 3 based on the image data taken by the camera 257 of the animal terminal 14a of each livestock 3 and the sensor data acquired by the sensor 262.

Further, based on the image data and the sensor data, it is possible to observe, for example, the ecosystem of the pasture land where the livestock 3 exists from the inside (from the viewpoint of the livestock 3) in addition to the habits of the livestock 3. This facilitates observation of events that are difficult to observe when observing the ecosystem of the pasture land from the outside based on images taken from the mobile object 2 or artificial satellites.

For example, it becomes easy to observe the types of organisms and plants existing around the livestock 3, the types of food eaten by the livestock 3, and the like. In addition, it will be possible to observe the soil and vegetation conditions of the pasture land in more detail.

For example, it is also possible to attach a device (hereinafter referred to as a biological device) equipped with a sensor such as a camera to an organism other than the livestock 3 and observe the ecosystem in which the organism exists from the inside.

As the target organisms, for example, organisms that are located in the upper part of the agroecosystem and have a shorter lifespan than humans are suitable. Specifically, for example, birds, honeybees, wild boars, vermin and the like are suitable. It should be noted that organisms located in the lower part of the agroecosystem are not very suitable because they are likely to be eaten before the ecosystem is sufficiently observed.

For example, birds are located near the top of agroecosystems and prey on almost all pests. Birds also have a very wide range of activity. Therefore, by attaching a biological device to a bird and observing the biological system in which the bird exists from the inside (from the viewpoint of the bird), the ecosystem can be observed in more detail. For the camera included in the biological device, for example, an omnidirectional camera can be used.

For example, it is possible to observe the number of times the bird has escaped from the foreign enemy and the type of the foreign enemy, the number of times the bird has preyed on the food and the type of food, the flight distance per flight of birds, and the like. For example, the distribution and density of feeding grounds can be estimated based on the flight distance per flight of birds, and the estimated distribution and density of feeding grounds can be used as an index when performing city greening, for example.

Further, for example, by attaching a biological device to a wild boar and observing the behavior pattern of a herd of wild boars, the type of food, and the like, it becomes possible to estimate the ecosystem of the mountain where the wild boar exists.

Furthermore, for example, by attaching a biological device to a vermin that devastates a field and observing the behavior pattern of the vermin and the type of food, it becomes possible to estimate the degree of deterioration of the mountain where the vermin exists (for example, pollution of the water field, and the like).

In addition, in order to reduce the power consumption of the biological device, it is desirable to transmit the data including the information extracted from the sensor data without transmitting the sensor data such as the image data as it is.

In addition, by adding a function to detect position information to a biological device, for example, after the death of the organism wearing the biological device, the position of the biological device (organism) can be identified and the biological device can be collected. Then, it becomes possible to collect the sensor data and the like accumulated in the biological device.

Further, for example, by providing a pollen trap in a honey bee hive and collecting pollen attached to the honey bee, it becomes possible to estimate the biological system and flowering phenology of surrounding flowers.

### <Modified Example of How to Use Earpiece 256>

For example, the earpiece 256 attached to the livestock 3 can be used for purposes other than the output of the guidance sound.

For example, the earpiece 256 may be used for noise canceling to attenuate the external sound heard by the livestock 3. For example, the livestock 3 is likely to be frightened when it feels a sign of a foreign enemy even if it is in a protected place such as a ranch. On the other hand, by attenuating the sound of the outside world, it is assumed that the livestock 3 has a reduced chance of feeling the sign of a foreign enemy, and for example, it becomes possible to sleep soundly at night.

Further, for example, in order to relax the livestock 3, the livestock 3 may be made to hear music or the sound of the livestock 3 emitting an a wave.

### 4. Others

In the present specification, the processing performed by a computer (CPU) in accordance with the program may not necessarily be performed chronologically in the order described in the flowchart. That is, the processing performed by the computer in accordance with the program also includes processing which is performed individually or in parallel (for example, parallel processing or processing by an object)

The program may be a program processed by one computer (processor) or may be distributed and processed by a plurality of computers. Further, the program may be a program transmitted to a remote computer to be executed.

Further, in the present specification, a system means a collection of a plurality of constituent elements (devices, modules (components), or the like) and whether all the constituent elements are contained in the same casing does not matter. Accordingly, a plurality of devices accommodated in separate casings and connected via a network and one device in which a plurality of modules are accommodated in one casing are all systems.

Embodiments of the present technology are not limited to the above-described embodiments and various modifications can be made within the scope of the present technology without departing from the gist of the present technology.

Further, for example, the present technology may have a configuration of clouding computing in which a plurality of devices share and process one function together via a network.

In addition, each step described in the above flowchart can be executed by one device or shared by a plurality of devices.

Further, in a case in which one step includes a plurality of processes, the plurality of processes included in the one step can be executed by one device or shared and executed by a plurality of devices.

The advantageous effects described in the present specification are merely exemplary and are not limited, and other advantageous effects may be achieved.

Note that the present technique may also have the following configurations.

(1) An information processing device including: an evaluation unit that evaluates a degree of contribution of a herd of grazing livestock to desert greening or ecosystem regeneration based on at least one of a behavior content of the herd and a state of a passing area which is an area through which the herd has passed.

The information processing device according to (1), wherein the evaluation unit evaluates the degree of contribution based on a moving distance of the herd.

The information processing device according to (2), wherein the evaluation unit further evaluates the degree of contribution based on dispersion of the herd.

The information processing device according to (2) or (3), wherein the evaluation unit further evaluates the degree of contribution based on a height difference of a route on which the herd has moved.

The information processing device according to any one of (1) to (4), wherein the evaluation unit evaluates the degree of contribution by comparing a behavior plan of the herd with an actual behavior content of the herd.

The information processing device according to any one of (1) to (5), wherein the evaluation unit evaluates the degree of contribution by comparing the states of the passing area before the herd has passed and after the herd has passed.

The information processing device according to any one of (1) to (6), wherein the evaluation unit evaluates the degree of contribution by comparing the state of the passing area with the state around the passing area.

The information processing device according to any one of (1) to (7), wherein the state of the passing area includes at least one of a vegetation state and a soil state of the passing area.

The information processing device according to (8), further including an observation unit that observes at least one of the vegetation state and the soil state of the passing area based on data obtained by a sensor attached to each of the livestock.

The information processing device according to any one of (1) to (9), further including a reward setting unit that sets a reward based on the degree of contribution.

The information processing device according to (10), wherein the reward setting unit controls presentation of the reward and a basis of the reward.

The information processing device according to any one of (1) to (11), further including a guidance unit that guides each of the livestock based on at least one of the state of each livestock and the state around each livestock.

The information processing device according to (12), wherein the guidance unit guides the livestock by letting the livestock hear a guidance sound through an earpiece worn by the livestock.

The information processing device according to (13), wherein the guidance sound corresponds to virtual surround.

The information processing device according to (13) or (14), wherein the guidance sound includes at least one of a sound of a foreign enemy of the livestock, a bark of a herding dog that guides the livestock, a voice of a person who guides the livestock, a conversation sound of the livestock, and a trigger sound conditioned so that the livestock performs a predetermined behavior.

The information processing device according to any one of (12) to (15), wherein the guidance unit guides the livestock by letting the herding dog hear a guiding sound through an earpiece worn by the herding dog that guides the livestock, and guiding the herding dog.

The information processing device according to any one of (1) to (16), further including a planning unit that creates a behavior plan of the herd based on at least one of a feature amount of a pasture land on which the herd is grazing and a feature amount of the herd.

The information processing device according to (17), wherein the planning unit creates a behavior plan of the herd so as to increase the degree of contribution.

The information processing device according to (18), wherein the planning unit creates the behavior plan based on at least one of conditions for increasing the consumption of withered grass, optimizing the timing of feeding green grass, suppressing the consumption of green grass until a growth period, increasing the distance traveled within a surface-hardened area in which a ground surface is hardened, and suppressing dispersion of the herd.

An information processing method for causing an information processing device to evaluate a degree of contribution of a herd of grazing livestock to desert greening or ecosystem regeneration based on at least one of a behavior content of the herd and a state of a passing area which is an area through which the herd has passed.

Reference Signs List

| | |
|---|---|
| 1 | Information processing system |
| 2 | Mobile object |
| 3-1 to 3-n | Livestock |
| 4 | Herding dog |
| 12 | Mobile terminal |
| 13 | Information processing terminal |
| 14a-1 to 14a-n, 14b | Animal terminal |
| 101 | CPU |
| 107 | Communication unit |
| 121 | Observation unit |
| 122 | Planning unit |
| 123 | Guidance unit |
| 124 | Evaluation unit |
| 125 | Reward setting unit |
| 151 | CPU |
| 156 | Camera |
| 157 | Position detection unit |
| 158 | Communication unit |
| 161 | Sensor |
| 171 | Data processing unit |
| 201 | CPU |
| 210 | Communication unit |
| 221 | Data processing unit |
| 251 | CPU |
| 256 | Earpiece |
| 257 | Camera |
| 258 | Position detection unit |
| 259 | Communication unit |
| 262 | Sensor |
| 271 | Data processing unit |

1. An information processing device comprising:
an evaluation unit that evaluates a degree of contribution of a herd of grazing livestock to desert greening or ecosystem regeneration based on at least one of a behavior content of the herd and a state of a passing area which is an area through which the herd has passed.

2. The information processing device according to claim 1, wherein
the evaluation unit evaluates the degree of contribution based on a moving distance of the herd.

3. The information processing device according to claim 2, wherein
the evaluation unit further evaluates the degree of contribution based on dispersion of the herd.

4. The information processing device according to claim 2, wherein
the evaluation unit further evaluates the degree of contribution based on a height difference of a route on which the herd has moved.

5. The information processing device according to claim 1, wherein
the evaluation unit evaluates the degree of contribution by comparing a behavior plan of the herd with an actual behavior content of the herd.

6. The information processing device according to claim 1, wherein
the evaluation unit evaluates the degree of contribution by comparing the states of the passing area before the herd has passed and after the herd has passed.

7. The information processing device according to claim 1, wherein
the evaluation unit evaluates the degree of contribution by comparing the state of the passing area with the state around the passing area.

8. The information processing device according to claim 1, wherein
the state of the passing area includes at least one of a vegetation state and a soil state of the passing area.

9. The information processing device according to claim 8, further comprising an observation unit that observes at least one of the vegetation state and the soil state of the passing area based on data obtained by a sensor attached to each of the livestock.

10. The information processing device according to claim 1, further comprising a reward setting unit that sets a reward based on the degree of contribution.

11. The information processing device according to claim 10, wherein
the reward setting unit controls presentation of the reward and a basis of the reward.

12. The information processing device according to claim 1, further comprising a guidance unit that guides each of the livestock based on at least one of the state of each livestock and the state around each livestock.

13. The information processing device according to claim 12, wherein
the guidance unit guides the livestock by letting the livestock hear a guidance sound through an earpiece worn by the livestock.

14. The information processing device according to claim 13, wherein
the guidance sound corresponds to virtual surround.

15. The information processing device according to claim 13, wherein
the guidance sound includes at least one of a sound of a foreign enemy of the livestock, a bark of a herding dog that guides the livestock, a voice of a person who guides the livestock, a conversation sound of the livestock, and a trigger sound conditioned so that the livestock performs a predetermined behavior.

16. The information processing device according to claim 12, wherein
the guidance unit guides the livestock by letting the herding dog hear a guiding sound through an earpiece worn by the herding dog that guides the livestock, and guiding the herding dog.

17. The information processing device according to claim 1, further comprising a planning unit that creates a behavior plan of the herd based on at least one of a feature amount of a pasture land on which the herd is grazing and a feature amount of the herd.

18. The information processing device according to claim 17, wherein
the planning unit creates a behavior plan of the herd so as to increase the degree of contribution.

19. The information processing device according to claim 18, wherein
the planning unit creates the behavior plan based on at least one of conditions for increasing the consumption of withered grass, optimizing the timing of feeding green grass, suppressing the consumption of green grass until a growth period, increasing the distance traveled within a surface-hardened area in which a ground surface is hardened, and suppressing dispersion of the herd.

20. An information processing method for causing an information processing device to evaluate a degree of contribution of a herd of grazing livestock to desert greening or ecosystem regeneration based on at least one of a behavior content of the herd and a state of a passing area which is an area through which the herd has passed.
